(19) United States
(12) Patent Application Publication
(10) Pub. No.: US 2012/0013858 A1
(43) Pub. Date: Jan. 19, 2012

(54) DIMMING DEVICE AND PROJECTOR-TYPE DISPLAY APPARATUS COMPRISING THE SAME

(76) Inventors: Hiroaki Fukunaga, Tokyo (JP); Takayuki Okada, Tokyo (JP)

(21) Appl. No.: 13/138,746

(22) PCT Filed: Mar. 31, 2009
(86) PCT No.: PCT/JP2009/056666

§ 371 Date: Sep. 23, 2011

(51) Int. Cl. G03B 21/14; G02B 26/02

(52) U.S. Cl. 353/97; 359/234

(57) ABSTRACT

A dimmer has a driving source, a driven body that is reciprocatingly moved by driving force generated by the driving source, and a transmission mechanism that transmits the driving force generated by the driving source. The transmission mechanism includes at least one rotary gear, and a conversion gear that converts the rotational motion of the rotary gear into linear motion. The light shielding plate is integrally provided with a drive pin in parallel with a rotating shaft of a light shielding plate. The driven body engages with the drive pin. The drive pin is rotated about the rotating shaft of the light shielding plate in association with the reciprocating movement of the driven body to cause the light shielding plate to rotate.

### TECHNICAL FIELD

The present invention relates to a dimmer that adjusts the quantity of a light entering an image forming device, and a projection type display device including the dimmer.

### BACKGROUND ART

For techniques of adjusting the quantity of light entering an image forming device mounted on a projection type display device, there are two techniques below. One is a diaphragm mechanism provided for a projection lens, and the other is a dimmer mechanism provided in an illumination optical system. Both the diaphragm mechanism and the dimmer mechanism adjust the quantity of light passing therethrough by open/close operations.

Dimmer mechanisms relating to the present invention will be described in detail. Dimmer mechanisms are described in JP2004-69966A (Document 1) and JP2007-71913A (Document 2).

The dimmer mechanisms described in Document 1 and Document 2 include a light shielding plate which is disposed between two integrator lenses constituting an illumination optical system and which is driven by a drive means. More specifically, the dimmer mechanisms described in Document 1 and Document 2 include two light shielding plates and a motor as a driving source for these light shielding plates. A drive gear is mounted on the rotating shaft of the motor, and gears (a first gear and a second gear) are mounted on the rotating shafts of the two light shielding plates, respectively. The first gear engages with the drive gear, and the second gear engages with the first gear. The two light shielding plates are rotated in the inside of the space between the two integrator lenses by driving force transmitted thorough the above-mentioned three gears, and the two light plates adjust the quantity of a light passing through the space.

### DISCLOSURE OF THE INVENTION

Problems that the Invention is to Solve

The positions of the rotating shafts of the light shielding plates are always determined in order that the two light shielding plates rotate in the inside of the space between the two integrator lenses. In other words, the distance between the two rotating shafts is always determined. Thus, in order to transmit driving force from the first gear to the second gear, it is necessary to increase the diameters of the first gear and the second gear. On the other hand, in order to transmit driving force without increasing the diameters of the first gear and the second gear, it is necessary to dispose another gear between the first gear and the second gear. Namely, it is necessary to increase the number of gears.

However, when the diameters of the first gear and the second gear are increased, the dimmer mechanism is increased in size. On the other hand, since backlash is increased when the number of gears is increased, the light shielding plates cannot be instantaneously driven at the same time. Furthermore, noise caused by the teeth of the gears colliding against each other is also increased.

### Means for Solving the Problems

A dimmer according to the present invention is a dimmer having a light shielding plate configured to rotate so as to enter an optical path or retract from the optical path for adjusting the quantity of light passing through the optical path. The dimmer according to the present invention has a driving source; a driven body configured to be reciprocatingly moved by a driving force generated by the driving source; and a transmission mechanism configured to transmit the driving force generated by the driving source to the driven body. The transmission mechanism includes at least a pair of rotary gears and a conversion gear configured to engage with the rotary gears for converting the rotational motion of the rotary gear into linear motion. The light shielding plate is integrally provided with a drive pin in parallel with the rotating shaft of the light shielding plate. The driven body engages with the drive pin. In the dimmer according to the present invention, the drive pin is rotated about the rotating shaft of the light shielding plate in association with the reciprocating move of the driven body to cause the light shielding plate to rotate.

### Effect of the Invention

According to the present invention, it is possible to implement a small-sized dimmer including a light shielding plate driven highly accurately at high speed.

The foregoing objects, features, and advantages of the present invention and the other ones will be apparent from the following descriptions and by referring to the accompanying drawings illustrating exemplary embodiments of the present invention.

### BRIEF DESCRIPTION OF THE DRAWINGS

FIG. 1 is a perspective view depicting the appearance of a dimmer according to a first embodiment;

FIG. 2 is an exploded perspective view depicting the dimmer shown in FIG. 1;

FIG. 3 is a perspective view depicting an assembly method for a driven body;

FIG. 4 is a perspective view depicting an assembly structure of light shielding plates;

FIG. 5 is a perspective view depicting an assembly structure of the driven body;

FIG. 6 is a perspective view depicting the operation of a transmission mechanism;

FIG. 7A is a perspective view depicting the position of the driven body in a state in which the light shielding plates are opened and in which an incident light is passable through the dimmer;

FIG. 7B is a perspective view depicting the position of the driven body in a state in which the light shielding plates are closed and an incident light is not passable through the dimmer;

FIG. 8A is a plan view depicting the relationship between the amounts of rotation of the light shielding plates and the travel distance of the driven body;

FIG. 8B is a plan view depicting the relationship between the amounts of rotation of the light shielding plates and the travel distance of the driven body;

FIG. 8C is a plan view depicting the relationship between the amounts of rotation of the light shielding plates and the travel distance of the driven body;

FIG. 9 is a perspective view depicting the appearance of a dimmer according to a second embodiment;

FIG. 10 is an exploded perspective view depicting the dimmer shown in FIG. 9;

FIG. 11 is a perspective view depicting an assembly method for a driven body;

FIG. 12 is a perspective view depicting an assembly structure of light shielding plates;

FIG. 13 is a perspective view depicting an assembly structure of the driven body;

FIG. 14 is a perspective view depicting the operation of a transmission mechanism;

FIG. 15A is a perspective view depicting the position of the driven body in a state in which the light shielding plates are opened and in which an incident light is passable through the dimmer;

FIG. 15B is a perspective view depicting the position of the driven body in a state in which the light shielding plates are closed and in which an incident light is not passable through the dimmer;

FIG. 16A is a plan view depicting the relationship between the amounts of rotation of the light shielding plates and the travel distance of the driven body;

FIG. 16B is a plan view depicting the relationship between the amounts of rotation of the light shielding plates and the travel distance of the driven body;

FIG. 16C is a plan view depicting the relationship between the amounts of rotation of the light shielding plates and the travel distance of the driven body;

FIG. 17 is an exploded perspective view depicting a projection type display device including the dimmer shown in FIG. 1;

FIG. 18 is an exploded perspective view depicting the projection type display device including the dimmer shown in FIG. 1; and

FIG. 19 is an enlarged perspective view depicting an integrator unit and a dimmer shown in FIG. 18.

### BEST MODE FOR CARRYING OUT THE INVENTION

### First Embodiment

Next, a first embodiment of a dimmer according to the present invention will be described with reference to the drawings.

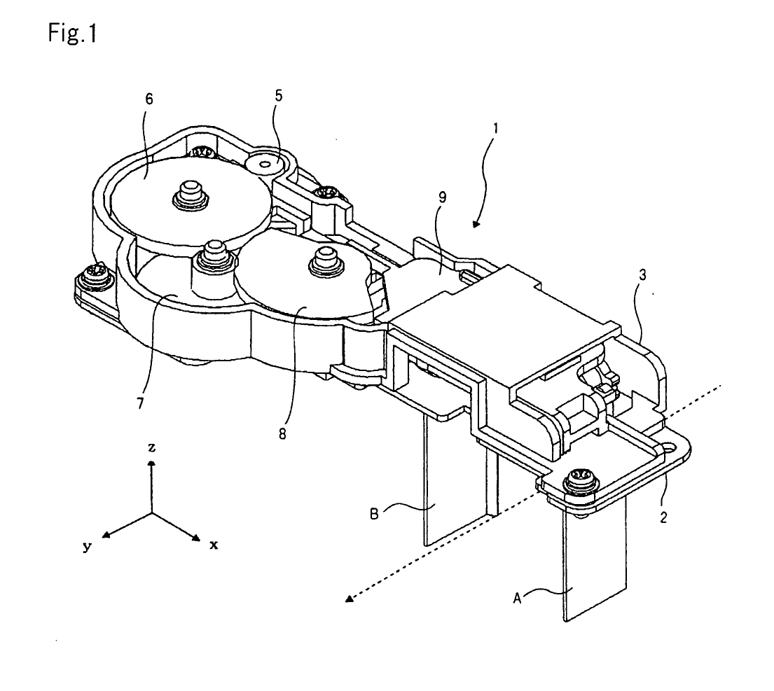

FIG. 1 is a perspective view depicting the appearance of dimmer 1 according to this embodiment. A chain line in the drawing indicates the center axis (the optical axis) of light adjusted by dimmer 1. Light enters dimmer 1 along the optical axis from the right side in the drawing. Dimmer 1 includes two rotatable light shielding plates (light shielding plate A and light shielding plate B) disposed on the optical path. Dimmer 1 rotates light shielding plate A and light shielding plate B to vary the quantity of a light passing through dimmer 1. The dimmer performance of dimmer 1 depends on the accuracy and responsiveness of the rotating operations of light shielding plate A and light shielding plate B. Thus, high resolution is demanded for controlling the rotating operations of light shielding plate A and light shielding plate B. In addition, what are also required for the rotating operations of light shielding plate A and light shielding plate B are high speed and silence. In the following, the structure of dimmer 1 according to this embodiment that satisfies the aforementioned demands will be described.

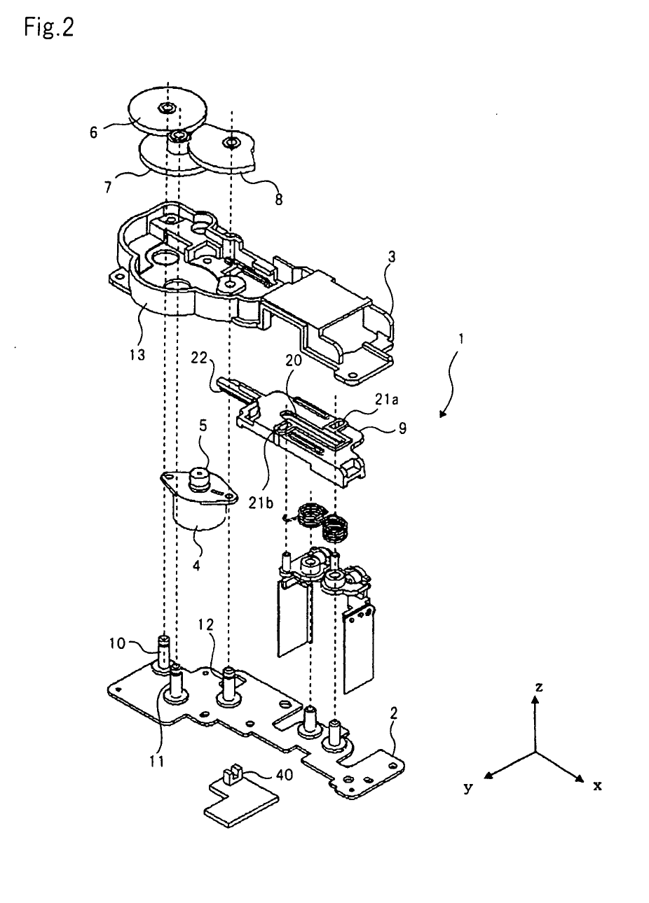

FIG. 2 is an exploded perspective view depicting dimmer 1 according to this embodiment. Dimmer 1 according to this embodiment has stainless steel base plate 2 and base plate 3. Base plate 3 is screwed to base plate 2. Light shielding plates A and B are rotatably supported on base plate 2. In the space between base plate 2 and base plate 3, a transmission mechanism is accommodated to transmit driving force produced by stepping motor 4 to light shielding plates A and B.

The transmission mechanism is formed of a plurality of rotary gears (gear 5, gear 6, gear 7, and gear 8) and driven body 9. Gear 5 is mounted on the rotating shaft of stepping motor 4. Gear 6 is mounted on shaft 10, and engages with gear 5. Gear 7 is mounted on shaft 11, and engages with gear 6. Gear 8 is mounted on shaft 12, and engages with gear 7. Moreover, a pinion gear (not shown) is provided on the underside of gear 8.

As described above, in this embodiment, in order to enhance the control resolution of the rotating operations of light shielding plates A and B, a plurality of rotary gears are combined to decelerated the rotation speed of stepping motor 4. More specifically, the rotation speed (the number of revolutions) of stepping motor 4 is decelerated (reduced) between gear 5 and gear 6, between gear 6 and gear 7, and between gear 7 and gear 8.

In addition, shafts 10, 11, and 12 that are the rotating shafts of gears 6, 7, and 8 are all made of stainless steel. These shafts 10, 11, and 12 are firmly fixed to base plate 2, and have a high rigidity. Base plate 3 is provided with gear protecting part 13 that surrounds these gears for protecting the gears. Gear protecting part 13 prevents an event in which some member collides against the gear to cause an external force to act on the gear.

Next, driven body 9 will be described. Opening 20 extending in an x-direction is formed at the center of driven body 9. On both sides of opening 20 in the crosswise direction, holes (pin guides 21a and 21b) extending in a y-direction are defined. Moreover, rack gear 22 extending in the x-direction is provided at the end of driven body 9. This rack gear 22 engages with the pinion gear provided on the underside of gear 8 for forming the transmission mechanism. In other words, the rotational motion of gear 8 is converted into linear motion by the rack and pinion gear. Consequently, driven body 9 is driven by stepping motor 4, and linearly reciprocated in the positive x-direction and in the negative x-direction.

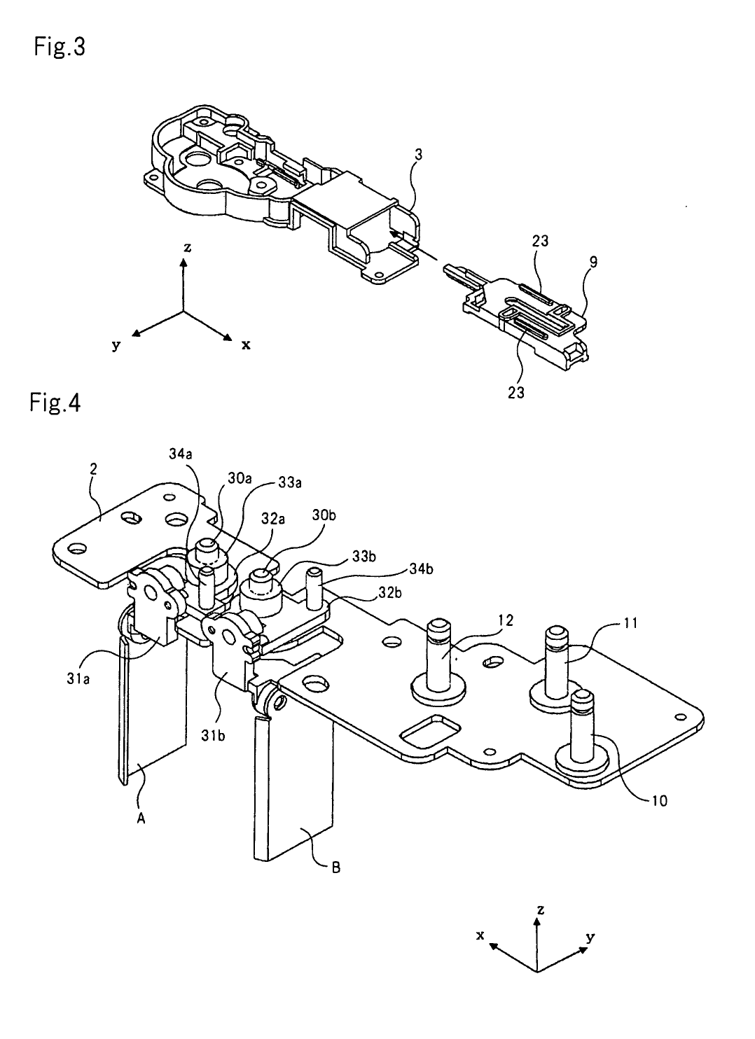

As shown in FIG. 3, driven body 9 having the aforementioned structure is inserted into the space between base plate 2 and base plate 3 from the lateral side of base plate 3, and slidably held therebetween. Two guide projections 23 extending in the x-direction are provided on the upper part of driven body 9 in parallel with each other. Guide projections 23 are fit into two guide grooves (not shown) formed on the underside of base plate 3. Namely, driven body 9 is guided so as to slide only in the positive and negative x-directions.

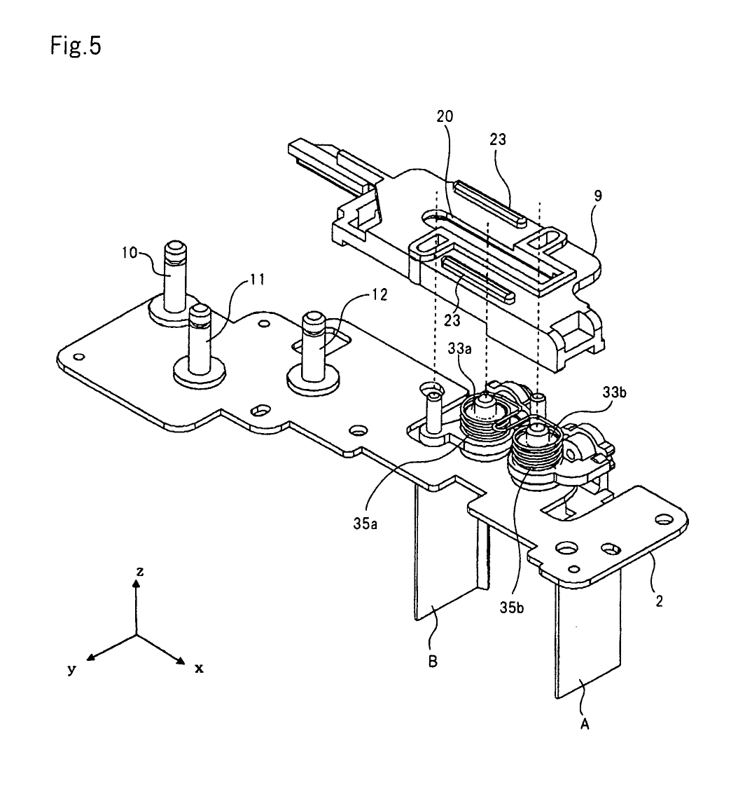

Next, light shielding plate A and light shielding plate B will be described. As shown in FIG. 4, light shielding plate A is rotatably supported about rotating shaft 30a provided on base plate 2. Light shielding plate B is rotatably supported about rotating shaft 30b provided on base plate 2. More specifically, light shielding plate A is mounted on support 32a through attachment 31a. Support 32a includes shaft sleeve 33a and drive pin 34a, and rotating shaft 30a is inserted into shaft sleeve 33a. Moreover, as shown in FIG. 5, coil spring 35a is wound around shaft sleeve 33a. Coil spring 35a biases light shielding plate A in such a way that light shielding plate A is rotated in the direction to open the optical path.

Again referring to FIG. 4, light shielding plate B is mounted on support 32b through attachment 31b. Support 32b includes shaft sleeve 33b and drive pin 34b, and rotating shaft 30b is inserted into shaft sleeve 33b. Moreover, as shown in FIG. 5, coil spring 35b is wound around shaft sleeve 33b. Coil spring 35b biases light shielding plate B in such a way that light shielding plate B is rotated in the direction to open the optical path. The aforementioned biases caused by coil springs 35a and 35b eliminate play between the individual gears.

Indeed, it is also possible to shape shaft sleeve 33a and drive pin 34a integrally with light shielding plate A. In addition, it is also possible to shape shaft sleeve 33b and drive pin 34b integrally with light shielding plate B.

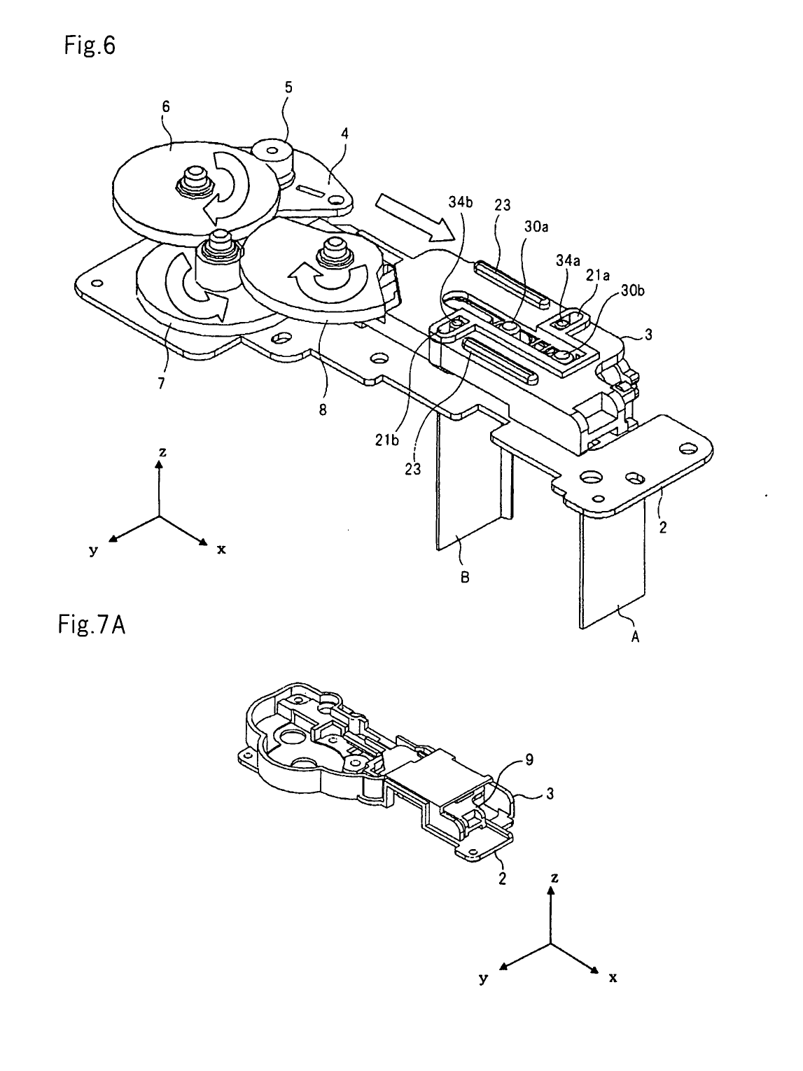

As shown in FIGS. 5 and 6, rotating shafts 30a and 30b have the diameter almost the same as the width of opening 20 in driven body 9. The heads of rotating shafts 30a and 30b are inserted into opening 20 in driven body 9 from below opening 20, and arranged in the x-direction. Thus, driven body 9 is also guided by rotating shafts 30a and 30b, and slides accurately in the x-direction. Furthermore, coil springs 35a and 35b wound on shaft sleeves 33a and 33b, respectively, bias driven body 9 upward in such a way that guide projections 23 of driven body 9 are pressed against the guide grooves in base plate 3. Consequently, play between guide projections 23 and the guide grooves is eliminated. As described above, the biases caused by coil springs 35a and 35b eliminate play between the individual components constituting the transmission mechanism, so that it is possible to accurately rotate light shielding plates A and B at high speed. Furthermore, noise is also reduced.

Drive pins 34a and 34b of supports 32a and 32b have the diameter almost the same as the width of pin guides 21a and 21b of driven body 9. As shown in FIGS. 5 and 6, drive pin 34a is inserted into pin guide 21a, and drive pin 34b is inserted into pin guide 21b. In other words, drive pins 34a and 34b engage with pin guides 21a and 21b.

For detecting the position of driven body 9, photodetection type position sensor 40 shown in FIG. 2 is used. When a light shielding portion provided on driven body 9 crosses the optical path of light emitted from position sensor 40, the light is blocked and the position of driven body 9 is detected. The position information of driven body 9 is inputted to a control unit, not shown, and used for controlling the rotation of stepping motor 4. Indeed, instead of the position of driven body 9, it is also possible to control the rotation of stepping motor 4 based on the detected result of the position of both or one of light shielding plate A and light shielding plate B.

Next, the rotating operations of light shielding plate A and light shielding plate B will be described. As shown in FIG. 6, when the rotating shaft (gear 5) of stepping motor 4 is rotated counterclockwise, gear 6 is rotated clockwise, gear 7 counterclockwise, and gear 8 clockwise, sequentially. The number of revolutions (the rotation speed) of stepping motor 4 is reduced (decelerated) between gear 5 and gear 6, reduced (decelerated) between gear 6 and gear 7, and reduced (decelerated) between gear 7 and gear 8. Namely, stepping motor 4 is decelerated in three steps.

The rotational motion of gear 8 is converted into linear motion by the above-described rack and pinion gear, and driven body 9 is moved in a positive x-direction. When driven body 9 is moved in the positive x-direction, pin guides 21a and 21b provided on driven body 9 are also moved in the same direction. Then, drive pins 34a and 34b inserted into pin guides 21a and 21b are pressed by the inner circumferential surfaces of pin guides 21a and 21b. Consequently, when light shielding plate A and light shielding plate B are rotated at the same time, rotating shafts 30a and 30b act as the rotation axes. At this time, drive pin 34a engaging with pin guide 21a is disposed at a position close to the light incident side more than rotating shaft 30a, and drive pin 34b engaging with pin guide 21b is disposed at a position close to the light emission side more than rotating shaft 30b. Thus, the rotation directions of light shielding plate A and light shielding plate B are reversed. In other words, drive pin 34a and drive pin 34b are provided on the opposite side to each other as the plane that includes the center axes of two rotating shafts 30a and 30b is a border.

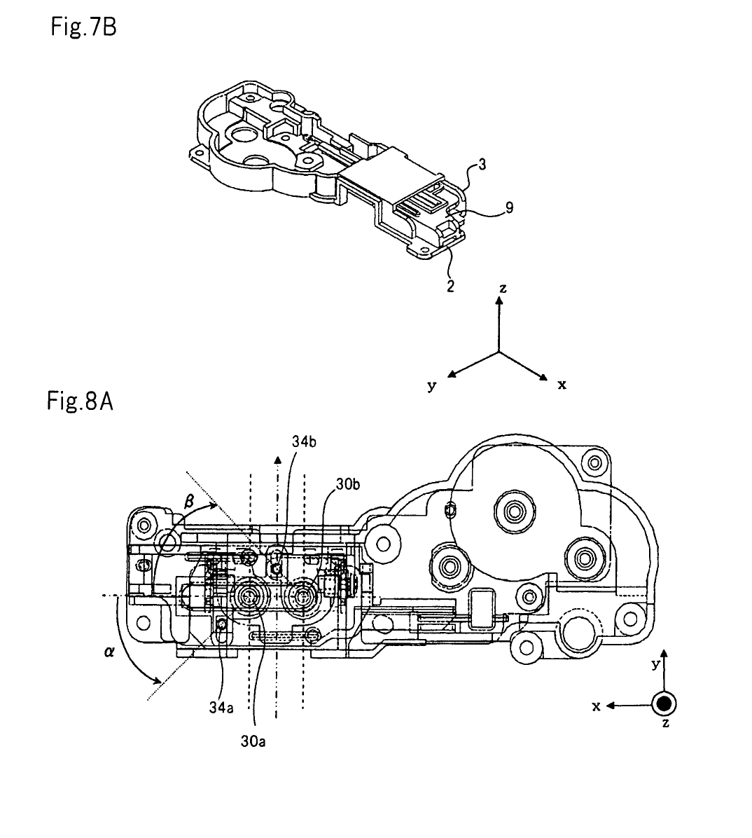

FIG. 7A shows the position of driven body 9 in a state in which light shielding plate A and light shielding plate B are opened and in which incident light is entirely passable through dimmer 1. FIG. 7B shows the position of driven body 9 in a state in which light shielding plate A and light shielding plate B are closed and in which incident light is not passable through dimmer 1. The transition from the state in which light shielding plate A and light shielding plate B are fully opened (FIG. 7A) to the state in which light shielding plate A and light shielding plate B are fully closed (FIG. 7B) is implemented by moving driven body 9 in the positive x-direction. On the other hand, the transition from the state in which light shielding plate A and light shielding plate B are fully closed (FIG. 7B) to the state in which light shielding plate A and light shielding plate B are fully opened (FIG. 7A) is implemented by moving driven body 9 in a negative x-direction. The moving stroke of driven body 9 in this operation is about 1 cm. In other words, it is sufficient that the moving stroke of driven body 9 necessary to rotate light shielding plate A and light shielding plate B at an angle of at an angle of 90° is about 1 cm, so that it is possible to downsize dimmer 1.

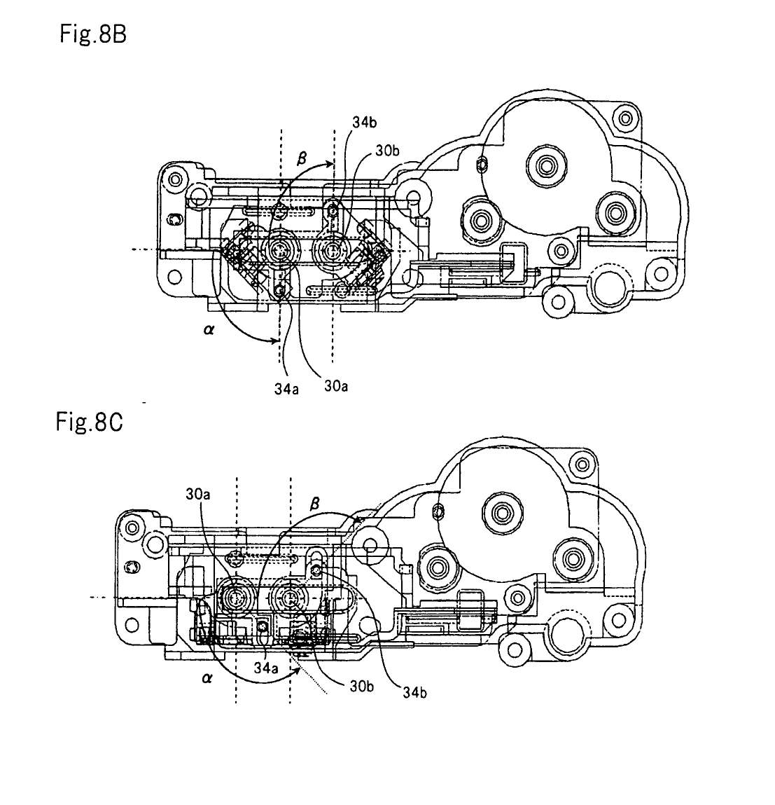

Next, the relationship between the amounts of rotation of light shielding plates A and B, and the travel distance of driven body 9 will be described more in detail. FIG. 8A shows a state in which light shielding plate A and light shielding plate B are fully closed and in which light is blocked. In the state shown in FIG. 8A, the travel distance of driven body 9 in the positive x-direction becomes the maximum. For convenience of explanation, it is defined that an angle formed by a straight line connecting the center of drive pin 34a to the center of rotating shaft 30a and a horizontal axis passing through the center between rotating shafts 30a and 30b is “angle α”. In addition, it is defined that an angle formed by a straight line connecting the center of drive pin 34b to the center of rotating shaft 30b and the aforementioned horizontal axis is “angle β”.

Angle α in the state shown in FIG. 8A is an angle of 45° on the light incident side, and angle β is an angle of 45° on the light emission side. Angle α and angle β are increased when driven body 9 is moved in the negative x-direction. When light shielding plate A and light shielding plate B are rotated at an angle of 45° (FIG. 8B), both angle α and angle β are at an angle of 90°.

FIG. 8C shows a state in which light shielding plate A and light shielding plate B are fully opened and a light is not blocked. In the state shown in FIG. 8C, the travel distance of driven body 9 in the negative x-direction becomes the maximum. Both angle α and angle are at an angle of 135° in the state shown in FIG. 8C.

Namely, drive pin 34a is rotated about rotating shaft 30a while sliding on the inner circumferential surface of pin guide 21a of driven body 9. Moreover, drive pin 34b is rotated about rotating shaft 30b while sliding on the inner circumferential surface of pin guide 21b of driven body 9. Consequently, light shielding plate A and light shielding plate B are rotated about the rotating shafts thereof.

In this embodiment, pin guides 21a and 21b are provided in such a way that the major axes of pin guides 21a and 21b are in parallel with the y-direction (the direction of the optical axis). Consequently, when light shielding plates A and B are rotated at an angle of 45°, the center between drive pins 34a and 34b is positioned at the center between pin guides 21a and 21b in the major axial direction thereof. However, it is also possible to provide pin guides 21a and 21b in such a way that the major axes of pin guides 21a and 21b are not in parallel with the y-direction (the direction of the optical axis). In the case where the major axes of pin guides 21a and 21b are tilted to the optical axis, the frictional resistance between drive pins 34a and 34b, and the inner circumferential surfaces of pin guides 21a and 21b is reduced. In addition, pin guides 21a and 21b may be formed in a curved-shape, not in a linear shape. In the case where pin guides 21a and 21b are in a curved-shape, the rotation speeds of light shielding plates A and B are changed even though driven body 9 is moved at a constant speed.

Pin guides 21a and 21 may be grooves, not holes. In short, it is sufficient that the pin guide can move the drive pins that engage with the pin guides as described above in association with the movement of driven body 9.

Here, optical energy absorption causes an increase in the temperature of the light shielding plate. Although the temperature of the light shielding plate varies depending on the amount of light applied to the light shielding plate or the amount of time during which light is applied on the light shielding plate, in the projection type display device, the temperature of the light shielding plate sometimes exceeds a temperature of 200°. When the light shielding plate is exposed in a high temperature state for a long time, it is sometimes necessary to exchange the light shielding plate because the light shielding plate gradually deteriorates (discolors or is deformed, or the like). Thus, in this embodiment, light shielding plates A and B are screwed to attachments 31a and 31b that are screwed to supports 32a and 32b. In other words, light shielding plates A and B are detachably (exchangeably) provided on supports 32a and 32b.

In addition, even in the case where the amount of time during which light is applied on the light shielding plate is short, the heat of the light shielding plate is transferred to the support to cause a micro deformation of the shaft sleeve or alteration or dissipation of grease coated on the shaft sleeve if the quantity of a light that is applied is large. Thus, desirably, attachments 31a and 31b provided between light shielding plates A and B and supports 32a and 32b are made of a heat-resisting plastic having a coefficient of thermal conductivity lower than that of metal. More specifically, a plastic material with a low coefficient of thermal conductivity and a high rigidity (polyphenylene sulfide (PPS) or liquid crystals polymer (LCP), for example) is preferable for the material of attachments 31a and 31.

### Second Embodiment 2

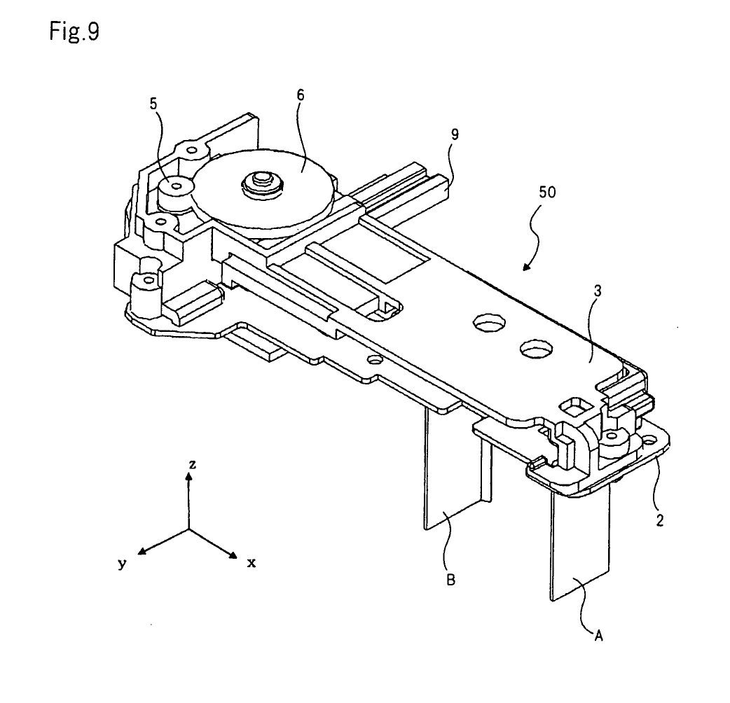

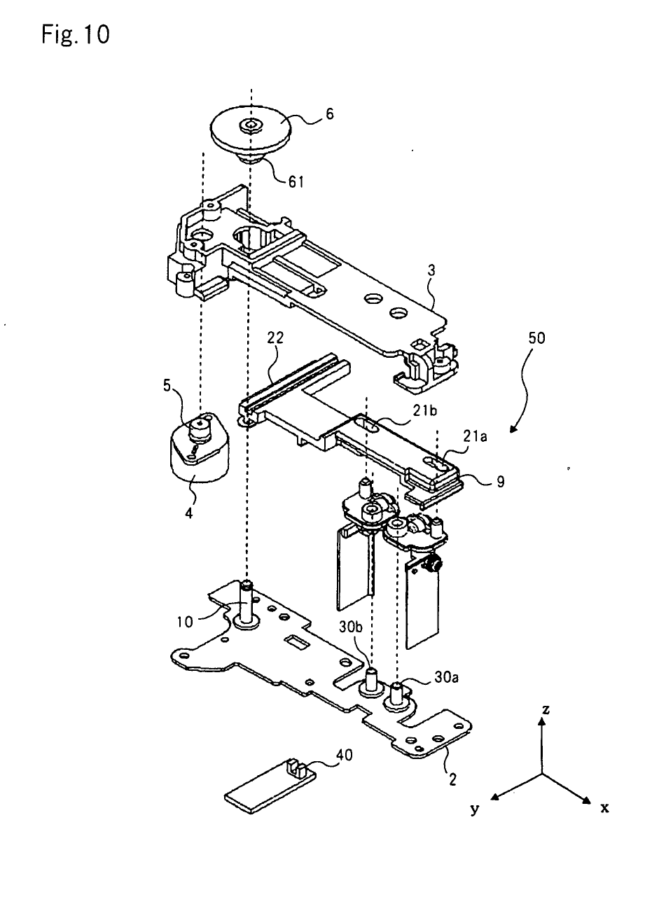

In the following, a second embodiment of a dimmer according to the present invention will be described with reference to the drawings. FIG. 9 is a perspective view depicting the appearance of dimmer 50 according to this embodiment, and FIG. 10 is an exploded perspective view depicting dimmer 50. The basic configuration of dimmer 50 according to this embodiment is the same as that of dimmer 1 according to the first embodiment. However, the moving direction of driven body 9 is different between dimmer 50 and dimmer 1. More specifically, driven body 9 of dimmer 1 is moved in a direction (in the positive and negative x-directions) orthogonal to the optical axis, whereas driven body 9 of dimmer 50 is moved parallel to the optical axis (in positive and negative y-directions). In other words, the moving direction of driven body 9 of dimmer 50 is different from the moving direction of driven body 9 of dimmer 1 at an angle of 90°.

Moreover, in order to implement further downsizing of dimmer, gears 7 and 8 shown in FIG. 2 are omitted in dimmer 50. Pinion gear 61 to engage with rack gear 22 of driven body 9 is provided on the underside of gear 6 (FIG. 10). Thus, in dimmer 50, the rotation speed (the number of revolutions) of stepping motor 4 is decelerated (reduced) between gear 5 and gear 6. It is noted that gear 5 may directly engage with rack gear 22 while omitting gear 6.

Shaft 10 that is the rotating shaft of gear 6 and rotating shafts 30a and 30b that are the rotating shafts of light shielding plates A and B are all made of stainless steel. As shown in FIG. 10, shafts 10, 30a, and 30b are firmly fixed to base plate 2, and have a high rigidity. Base plate 2 and base plate 3 shown in FIG. 10 are fixed to each other with screws. Driven body 9 is slidably held in the inside of the space between base plate 2 and base plate 3.

Holes (pin guides 21a and 21b) extending in the x-direction are formed in driven body 9. Moreover, rack gear 22 extending in the y-direction is provided at the end of driven body 9. This rack gear 22 engages with pinion gear 61 provided on the underside of gear 6 to form a rack and pinion gear, and this is as described above. In other words, the rotational motion of gear 6 is converted into linear motion by the rack and pinion gear. Consequently, driven body 9 is driven by stepping motor 4, and linearly reciprocated in the positive and negative y-directions.

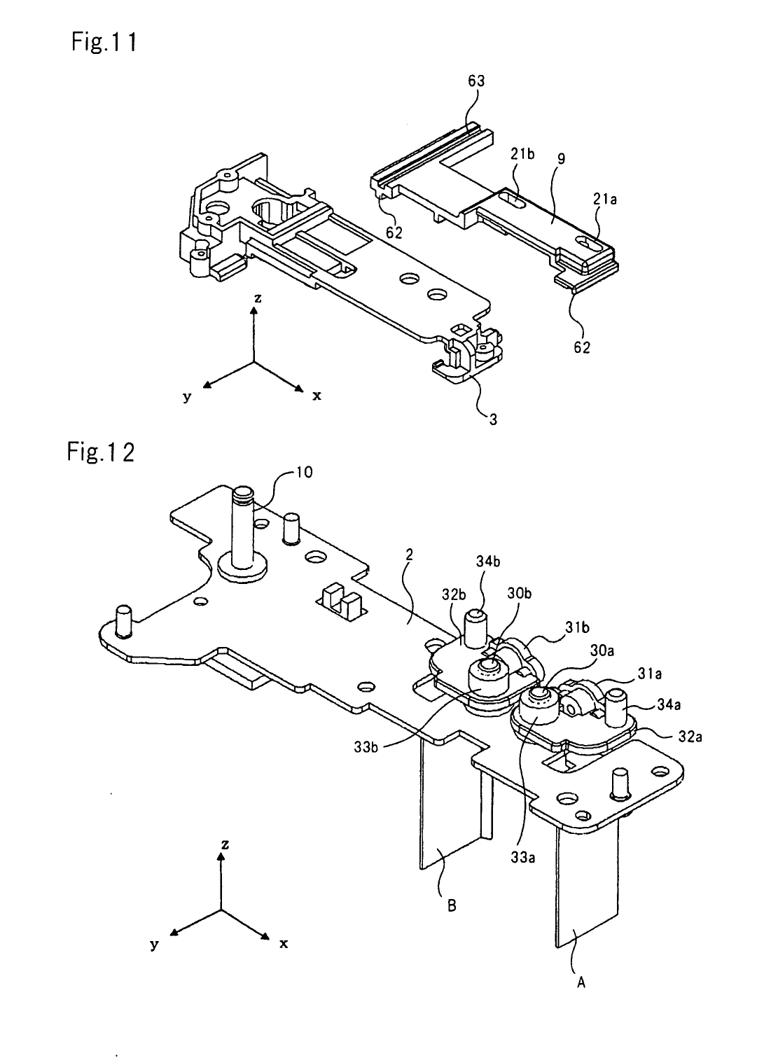

As shown in FIG. 11, driven body 9 having the aforementioned structure is inserted into the space between base plate 2 and base plate 3 from the front of base plate 3, and slidably held therebetween. Driven body 9 is provided with two guide projections 62 and a single guide groove 63 extending in the y-direction in parallel with each other. Guide projections 62 are fit into guide grooves provided in base plate 3. A guide projection provided on base plate 3 is fit into guide groove 63. Namely, driven body 9 is guided so as to slide only in the positive and negative y-directions.

Next, light shielding plate A and light shielding plate B will be described. As shown in FIG. 12, light shielding plate A is rotatably supported about rotating shaft 30a provided on base plate 2. Light shielding plate B is rotatably supported about rotating shaft 30b provided on base plate 2. More specifically, light shielding plate A is mounted on support 32a through attachment 31a. Support 32a includes shaft sleeve 33a and drive pin 34a, and rotating shaft 30a is inserted into shaft sleeve 33a.

Light shielding plate B is mounted on support 32b through attachment 31b. Support 32b includes shaft sleeve 33b and drive pin 34b, and rotating shaft 30b is inserted into shaft sleeve 33b.

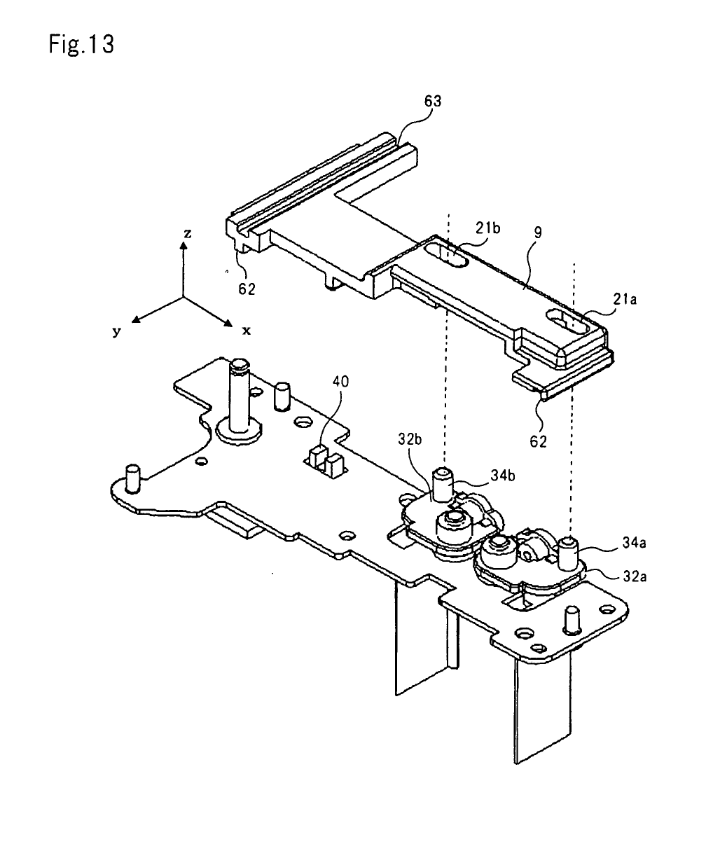

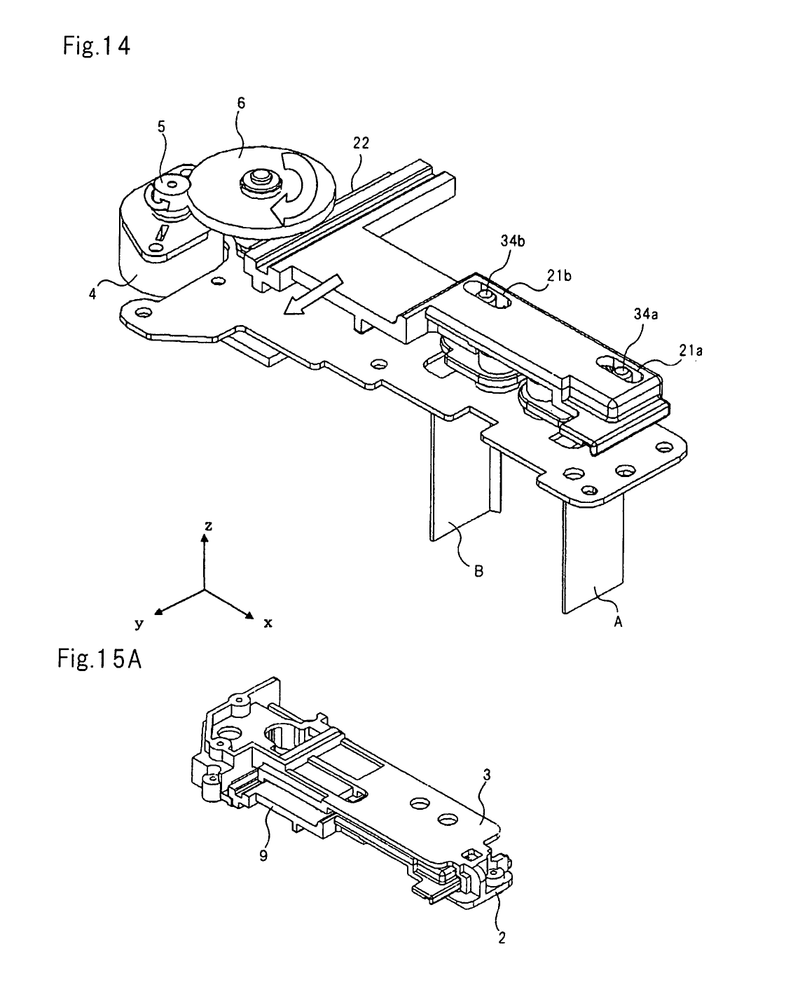

Drive pins 34a and 34b of supports 32a and 32b have a diameter almost the same as the width of pin guides 21a and 21b of driven body 9. As shown in FIGS. 13 and 14, drive pin 34a is inserted into pin guide 21a, and drive pin 34b is inserted into pin guide 21b.

For detecting the position of driven body 9, photodetection type position sensor 40 shown in FIG. 10 is used. When a light shielding unit provided on driven body 9 crosses the optical path of light emitted from position sensor 40, the light is blocked to detect the position of driven body 9. The position information of driven body 9 is inputted to a control unit, not shown, and used for controlling the rotation of stepping motor 4. Indeed, instead of the position of driven body 9, it is also possible to control the rotation of stepping motor 4 based on the detected result of the position of both or one of light shielding plate A and light shielding plate B.

Next, the rotating operations of light shielding plate A and light shielding plate B will be described. As shown in FIG. 14, when the rotating shaft (gear 5) of stepping motor 4 is rotated counterclockwise, gear 6 is rotated clockwise. The rotational motion of gear 6 is converted into linear motion by the above-described rack and pinion gear, and driven body 9 is moved in the positive y-direction. When driven body 9 is moved in the positive y-direction, pin guides 21a and 21b provided on driven body 9 are also moved in the same direction. Then, drive pins 34a and 34b inserted into pin guides 21a and 21b are pressed by the inner circumferential surfaces of pin guides 21a and 21b. Consequently, when light shielding plate A and light shielding plate B are rotated in the reverse directions at the same time, rotating shafts 30a and 30b act as the rotation axes.

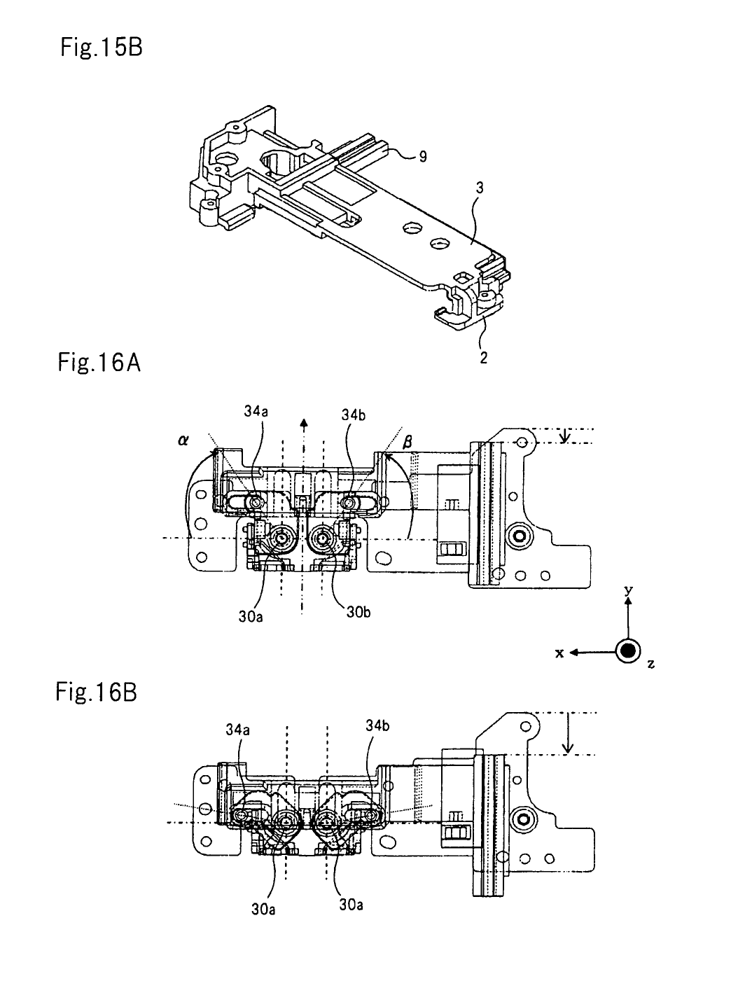

FIG. 15A shows the position of driven body 9 in a state in which light shielding plate A and light shielding plate B are opened and in which incident light is entirely passable through dimmer 50. FIG. 15B shows the position of driven body 9 in a state in which light shielding plate A and light shielding plate B are closed and in which incident light is not passable through dimmer 50. The transition from the state in which light shielding plate A and light shielding plate B are fully opened (FIG. 15A) to the state in which light shielding plate A and light shielding plate B are fully closed (FIG. 15B) is implemented by moving driven body 9 in the negative y-direction. On the other hand, the transition from the state in which light shielding plate A and light shielding plate B are fully closed (FIG. 15B) to the state in which light shielding plate A and light shielding plate B are fully opened (FIG. 15A) is implemented by moving driven body 9 in the positive y-direction. The moving stroke of driven body 9 in this operation is about 1.5 cm.

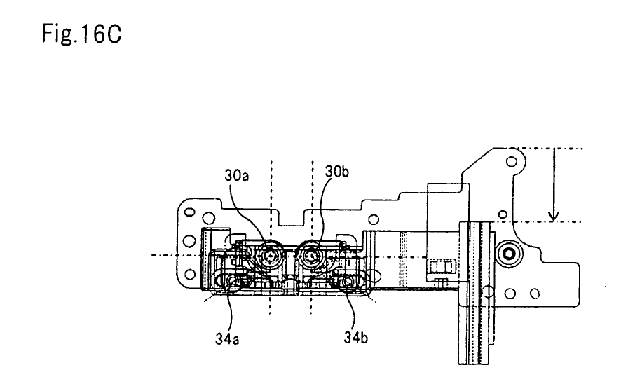

Next, the relationship between the amounts of rotation of light shielding plates A and B, and the travel distance of driven body 9 will be described more in detail. FIG. 16A shows a state in which light shielding plate A and light shielding plate B are fully closed and a light is blocked. The travel distance of driven body 9 in the positive y-direction becomes the maximum in the state shown in FIG. 16A. For convenience of explanation, it is defined that an angle formed by a straight line connecting the center of drive pin 34a to the center of rotating shaft 30a and a horizontal axis passing through the center between rotating shafts 30a and 30b is “angle α”. In addition, it is defined that an angle formed by a straight line connecting the center of drive pin 34b to the center of rotating shaft 30b and the aforementioned horizontal axis is “angle β”.

Angle α and angle β are at an angle of 55° on the light emission side in the state shown in FIG. 16A. Angle α and angle β are increased when driven body 9 is moved in the negative y-direction. When light shielding plate A and light shielding plate B are rotated at an angle of 45° (16B), angle α and angle β are at an angle of 10° on the light emission side.

FIG. 16C shows a state in which light shielding plate A and light shielding plate B are fully opened and in which light is not blocked. The travel distance of driven body 9 in the negative y-direction becomes the maximum in the state shown in FIG. 16C. Angle α and angle β are at an angle of 35° on the light incident side in the state shown in FIG. 16C.

Namely, drive pin 34a is rotated about rotating shaft 30a while sliding on the inner circumferential surface of pin guide 21a of driven body 9. In addition, drive pin 34b is rotated about rotating shaft 30b while sliding on the inner circumferential surface of pin guide 21b of driven body 9. Consequently, light shielding plate A and light shielding plate B are rotated about the rotating shafts thereof.

In this embodiment, pin guides 21a and 21b are provided in such a way that the major axes of pin guides 21a and 21b are parallel to the x-direction. However, it is also possible to tilt the major axes of pin guides 21a and 21b to the x-direction. In addition, pin guides 21a and 21b may be formed in a curved-shape, not in a linear shape. When the major axes of pin guides 21a and 21b are tiled to the x-direction, the frictional resistance between drive pins 34a and 34b, and the inner circumferential surfaces of pin guides 21a and 21b is reduced. When pin guides 21a and 21b are formed in a curved-shape, the rotation speeds of light shielding plates A and B are changed even though driven body 9 is moved at a constant speed.

### Third Embodiment 3

In the following, an exemplary embodiment of a projection type display device according to the present invention will be described. A projection type display device according to this embodiment includes dimmer 1 according to the first embodiment.

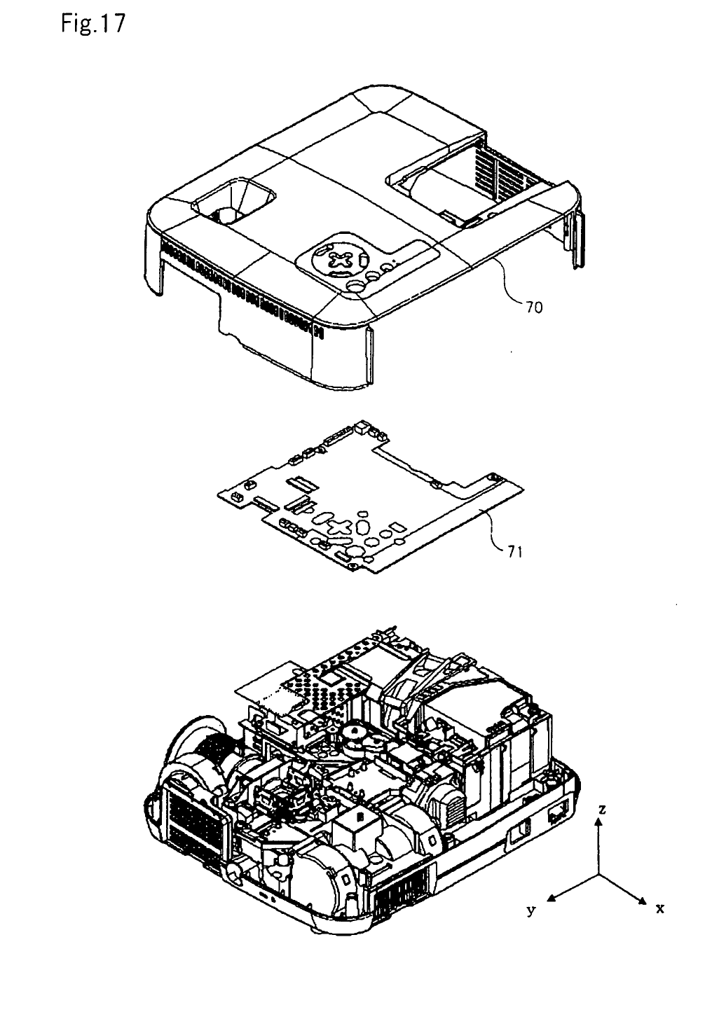

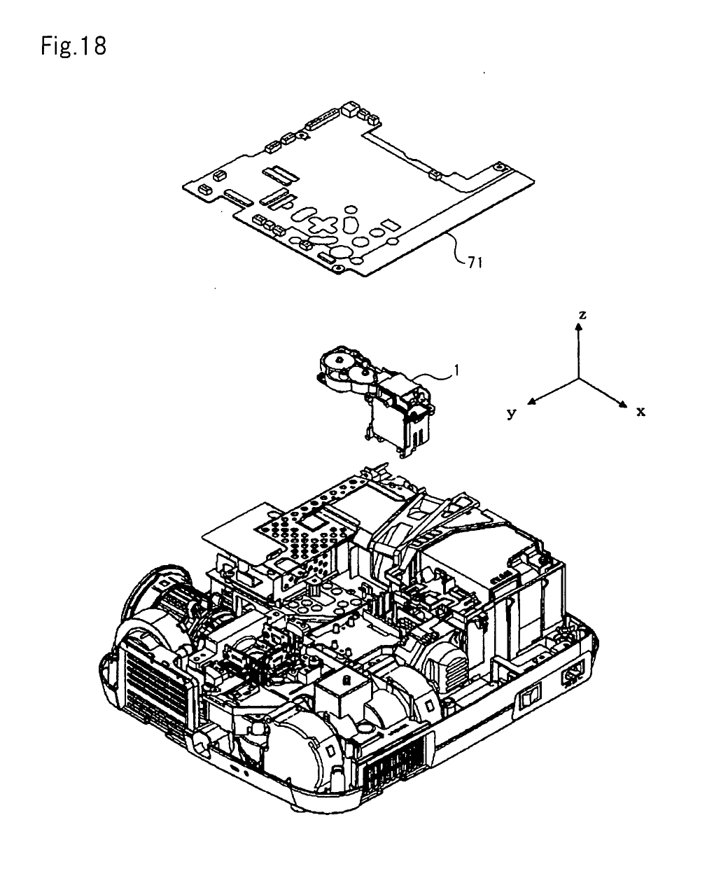

FIGS. 17 and 18 are exploded perspective views depicting the projection type display device according to this embodiment. In FIG. 18, upper cabinet 70 and main substrate 71 are removed. In FIG. 18, the upper cabinet (not shown), the main substrate, and dimmer 1 are removed.

The main components of the projection type display device are a power supply unit, an optical engine, and a projection lens. The power supply unit stably supplies electric power to electronic circuits including the main substrate and a lamp or the like in the lamp unit. The optical engine has an illumination optical system including a color separation optical system that separates a light emitted from the lamp into R (Red), G (Green), and B (Blue) colored lights. The optical engine has an image forming device (in this embodiment, a liquid crystal device) that optically modulates the individual colored lights and generates images. The optical engine further has a color composition means for combining individual color images to generate a full color image. The projection lens enlarges and projects images generated by the optical engine.

Dimmer 1 is mounted on the optical engine. More specifically, dimmer 1 is provided in the illumination optical system of the optical engine. Dimmer 1 adjusts the quantity of a light applied to the liquid crystal device by the illumination optical system. More specifically, dimmer 1 adjusts the quantity of light passing through the integrator unit constituting the illumination optical system. The quantity of the light passing through the integrator unit is adjusted according to the brightness of an image generated by the liquid crystal device. It is possible to improve the contrast of projection images by this dimming operation.

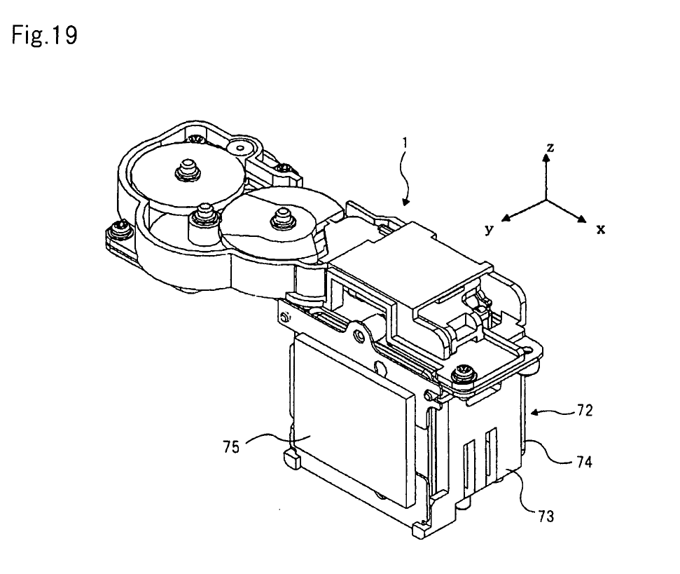

FIG. 19 shows the relationship between dimmer 1 and integrator unit 72. As shown in FIG. 19, integrator unit 72 has frame 73, two integrator lenses (not shown) held in the inside of frame 73, and polarization converting devices 74 and 75 provided in the front and rear of frame 73. The integrator lenses and polarization converting devices 74 and 75 are mounted on the same frame 73, and integrated with each other.

Dimmer 1 is mounted on integrator unit 72 in the aforementioned structure, and integrated with integrator unit 72. The reason why dimmer 1 can be integrated with integrator unit 72 is that dimmer 1 is small and lightweight.

Dimmer 1 is screwed to integrator unit 72, and detachable from integrator unit 72. Thus, dimmer 1 is easily mounted on integrator unit 72. Moreover, the maintenance of dimmer 1 or integrator unit 72 is also easy.

Furthermore, for some models of projection type display devices having the same optical engine, it is also possible that some models include the dimmer, whereas some models do not include the dimmer. Namely, it is possible to increase product variations using the same optical engine. Moreover, it is also possible to mount the dimmer later on the existing projection type display device.

1. A dimmer having a light shielding plate configured to rotate so as to enter an optical path or retract from the optical path for adjusting a quantity of light passing through the optical path, the dimer comprising:
a driving source;
a driven body configured to be reciprocatingly moved by a driving force generated by the driving source; and
a transmission mechanism configured to transmit the driving force generated by the driving source to the driven body, wherein:
the transmission mechanism includes at least one rotary gear and a conversion gear to convert a rotational motion of the rotary gear into linear motion;
the light shielding plate is integrally provided with a drive pin in parallel with a rotating shaft of the light shielding plate;
the driven body engages with the drive pin; and
the drive pin is rotated about the rotating shaft of the light shielding plate in association with the reciprocating move of the driven body to cause the light shielding plate to rotate.

2. The dimmer according to claim 1, wherein the drive pin is provided on a support mounted on the light shielding plate.

3. The dimmer according to claim 1, wherein the drive pin and the light shielding plate are integrally formed.

4. The dimmer according to claim 1, further comprising a plurality of the rotary gears,
wherein a reduction gear is formed of the plurality of the rotary gears.

5. The dimmer according to claim 1,
wherein the drive pin is inserted into a hole or groove formed in the driven body.

6. The dimmer according to claim 1, further comprising a first light shielding plate and a second light shielding plate,
wherein an engaging position of the drive pin provided on the first light shielding plate with the driven body and an engaging position of the drive pin provided on the second light shielding plate with the driven body are defined so that the first light shielding plate and the second light shielding plate rotate in opposite directions.

7. The dimmer according to claim 6,
wherein the driven body is reciprocatingly moved in a direction orthogonal to or parallel with the optical axis of the light passing through the optical path.

8. The dimmer according to claim 1, further comprising:
a sensor configured to detect a position of the driven body; and
a control unit configured to control the driving source based on a detected result of the sensor.

9. The dimmer according to claim 1, further comprising:
a sensor configured to detect a position of the light shielding plate; and
a control unit configured to control the driving source based on a detected result of the sensor.

10. A projection type display device to enlarge and project an image formed by an image forming device, the projection type display device comprising:
a light source;
an illumination optical system configured to cause light, emitted from the light source, to enter the image forming device; and
dimming means for adjusting the light entering the image forming device, wherein:
the dimming means comprises the dimmer according to claim 1; and
the light shielding plate of the dimmer is placed between two integrator lenses forming the illumination optical system.

11. The projection type display device according to claim 10,
wherein the dimmer is integrated with an integrator unit including the two integrator lenses, and detachable from a main body of the projection type display device along with the integrator unit.
